(19) United States
(12) Patent Application Publication
(10) Pub. No.: US 2013/0060958 A1
(43) Pub. Date: Mar. 7, 2013

(54) METHOD AND APPARATUS FOR PLAYING BACK RECORDED CONTENT IN WIRELESS COMMUNICATION SYSTEM

(71) Applicants: Ji Eun Keum, Gyeonggi-do (KR); Jae Yeon Song, Seoul (KR); Sung Ryeul Rhyu, Gyeonggi-do (KR)

(72) Inventors: Ji Eun Keum, Gyeonggi-do (KR); Jae Yeon Song, Seoul (KR); Sung Ryeul Rhyu, Gyeonggi-do (KR)

(73) Assignee: Samsung Electronice Co., Ltd., Gyeonggi-do (KR)

(21) Appl. No.: 13/697,198

(22) PCT Filed: Jun. 16, 2011
(86) PCT No.: PCT/KR2011/004398

§ 371 Date: Nov. 9, 2012

(30) Foreign Application Priority Data
Jun. 16, 2010 (KR) 10-2010-0057121

(51) Int. Cl. G06F 15/16

(52) U.S. Cl. 709/231

(57) ABSTRACT

A method and apparatus for playing back recorded content in a wireless communication system are disclosed. The method of playing back recorded content for a client includes: accepting a playback request for recorded content; selecting a first bit rate of a content segment forming the streaming content at the time of playback request; comparing a second bit rate of a content segment forming the recorded content with the selected first bit rate; and playing back one of the content segment forming the recorded content and a corresponding content segment received from a server according to comparison results. Hence, the user may play back recorded content in better quality through comparing the bit rate of a recorded content segment with the optimal bit rate of the corresponding content segment in consideration of network and client conditions at the time of playback request.

### TECHNICAL FIELD

The present invention relates to a method and apparatus for playing back recorded content in a wireless communication system and, more particularly, to a method and apparatus that enables a user to record content being transmitted using adaptive streaming technology and to play back the recorded content as higher quality content for viewing.

### BACKGROUND ART

With increased demand for online content in recent years, smooth delivery of content has become an important issue. In this respect, adaptive streaming, where the bit rate of content being transmitted varies smoothly according to changes in available transmission bandwidths and user equipment capabilities, has attracted attention.

In adaptive streaming, content to be sent is subdivided into segments and these content segments are delivered through the HTTP protocol to a user terminal in a bit rate suitable for terminal conditions so that the user may play back the content without delay or discontinuance. Adaptive streaming has been handled by various standardization organizations.

In a current adaptive streaming service, when the user requests recording of live content, the content segments that are adapted to conditions at the time of transmission are stored in the user storage device. Later, when the user views the recorded content, the content is played back in a quality level at the time of recording.

### DISCLOSURE OF INVENTION

### Technical Problem

When the available transmission bandwidth is not sufficient for high-quality content owing to heavy traffic at the time of transmission, content segments with low bit rates are recorded. Hence, later, although the available bandwidth is sufficient at the time of playback, the user may have to view the recorded content with low bit rates.

### Solution to Problem

The present invention has been made in view of the above problems, and the present invention provides a method and apparatus that enables the user to record content being transmitted using adaptive streaming technology and to play back the recorded content as higher quality content at the time of viewing.

In accordance with an exemplary embodiment of the present invention, there is provided a method of playing back recorded content for a client in a wireless communication system, including: accepting a playback request for recorded content; selecting a first bit rate of a content segment forming the streaming content at the time of playback request; comparing a second bit rate of a content segment forming the recorded content with the first bit rate selected at the time of playback request; and playing back one of the content segment forming the recorded content and a corresponding content segment received from a content providing server according to the comparison results.

In accordance with another exemplary embodiment of the present invention, there is provided a content playback apparatus for playing back recorded content in a wireless communication system, including: a wireless communication unit connecting to a content delivery server or a content providing server to send and receive signals; a storage unit storing recorded content; and a control unit controlling a process of selecting, in response to a playback request for recorded content, a first bit rate of a content segment forming streaming content, comparing a second bit rate of a content segment forming the recorded content with the first bit rate selected at the time of playback request, and playing back one of the content segment forming the recorded content and a corresponding content segment received from the content providing server according to the comparison results.

In accordance with another exemplary embodiment of the present invention, there is provided a method of playing back recorded content for a client in a wireless communication system, including: examining, in response to a recording request for content, bit rates of content segments forming the requested content and identifying content segments to be downloaded; selecting content segments having a bit rate greater than or equal to a preset threshold value among the content segments forming the requested content, and receiving the selected content segments from a content providing server and storing the received content segments; receiving, when an additional content segment that is a content segment to be downloaded and is not yet received from the content providing server has a bit rate greater than or equal to the preset threshold value, the additional content segment from the content providing server and storing the received additional content; combining the received content segments; and playing back, in response to a playback request for recorded content, the combined content segments.

In accordance with another exemplary embodiment of the present invention, there is provided a content playback apparatus for playing back recorded content in a wireless communication system, including: a wireless communication unit connecting to a content delivery server or a content providing server to send and receive signals; a storage unit storing recorded content; and a control unit controlling a process of examining, in response to a recording request for particular content, bit rates of content segments forming the requested content and identifying content segments to be downloaded, selecting content segments having a bit rate greater than or equal to a preset threshold value among the content segments forming the requested content, receiving the selected content segments from a content providing server and storing the received content segments, and further receiving, when an additional content segment that is a content segment to be downloaded and is not yet received from the content providing server has a bit rate greater than or equal to the preset threshold value, the additional content segment from the content providing server and storing the received additional content.

In a feature of the present invention, for playback of recorded content in an adaptive streaming environment, the bit rate of a recorded content segment is compared with the optimum bit rate of the corresponding content segment in consideration of network and client conditions at the time of request and the content segment with a higher bit rate is played back. Hence, the user may view recorded content, which was recorded when network or client conditions were not good, in a better quality level.

### Advantageous Effects of Invention

The present invention enables the user to play back recorded content in a better quality level by comparing the bit rate of a recorded content segment with the optimal bit rate of the corresponding content segment in consideration of network and client conditions at the time of playback request.

### BRIEF DESCRIPTION OF DRAWINGS

The features and advantages of the present invention will be more apparent from the following detailed description in conjunction with the accompanying drawings, in which:

FIG. 1 is a sequence diagram illustrating a related art procedure for playing back recorded content in an adaptive streaming environment;

FIGS. 2 and 3 are a sequence diagram illustrating a procedure for playing back recorded content according to an embodiment of the present invention;

FIG. 4 is a flowchart of a procedure performed by a client according to an exemplary embodiment of the present invention;

FIG. 5 is a sequence diagram illustrating a procedure for playing back recorded content according to another embodiment of the present invention; and

FIG. 6 is a block diagram of the client of FIG. 2.

### MODE FOR THE INVENTION

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

In the description, content may be composed of one or more content segments.

For convenience of description, entity names or terms defined by standardization bodies such as 3rd Generation Partnership Project (3GPP), Open IPTV Forum (OIPF) or MPEG are used in the description. However, the present invention is not limited by such names or terms, and may be applied to other systems in the relevant field.

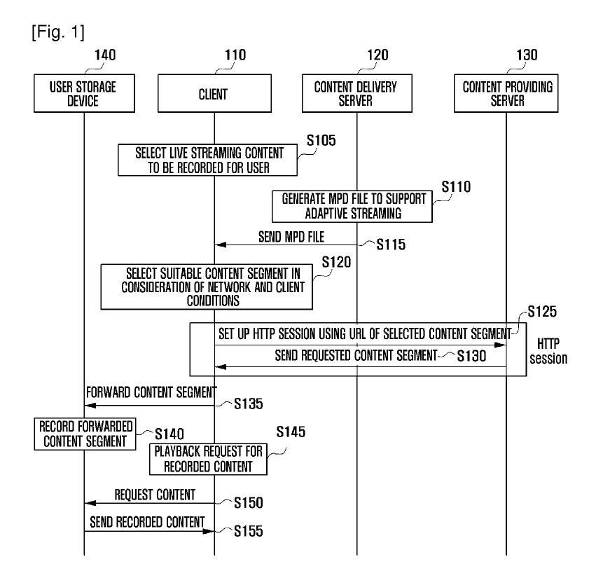

FIG. 1 is a sequence diagram illustrating a related art procedure for playing back recorded content in an adaptive streaming environment.

Referring to FIG. 1, the client 110 selects live streaming content to be recorded according to user selection (S105). The content delivery server 120 generates content configuration information to support adaptive streaming (S110). The content configuration information enables the client 110 to play back desired content, and may include at least one of content address like URL, streaming time, the number of segments, duration of each segment and bandwidth of each segment. The content configuration information may be a media presentation description (MPD) file. In the following description, the content configuration information is assumed to be an MPD file. The content delivery server 120 sends the generated MPD file to the client 110 (S115).

The client 110 selects a content segment having the highest bit rate in consideration of current network and client conditions as a content segment to be downloaded on the basis of details of the received MPD file (S120).

The client 110 sends a session setup message to the content providing server 130 indicated by an address of the content segment to be downloaded (S125). In adaptive streaming, the session may be an HTTP session. Thereby, a session for adaptive streaming is established between the client 110 and the content providing server 130.

After session setup, the content providing server 130 sends the requested content segment to the client 110 (S130). The client 110 forwards the received content segment to the user storage device 140 (S135), at which the content segment is recorded and stored (S140).

Later, when a user request for the recorded content is received (S145), the client 110 requests the user storage device 140 to send the recorded content (S150), receives the recorded content (S155), and plays back the recorded content.

In an existing method for recorded content playback, when the available transmission bandwidth is not sufficient for high-quality content owing to heavy traffic at the time of transmission, content segments with low bit rates are received and recorded. Hence, later, although the available bandwidth is sufficient at the time of playback, the user may have to view the recorded content having low bit rates.

To solve such a problem, the present invention provides a method in which the bit rate of a recorded content segment is compared with the optimum bit rate of the corresponding content segment in consideration of network and client conditions at the time of playback request and the content segment with a higher bit rate is played back.

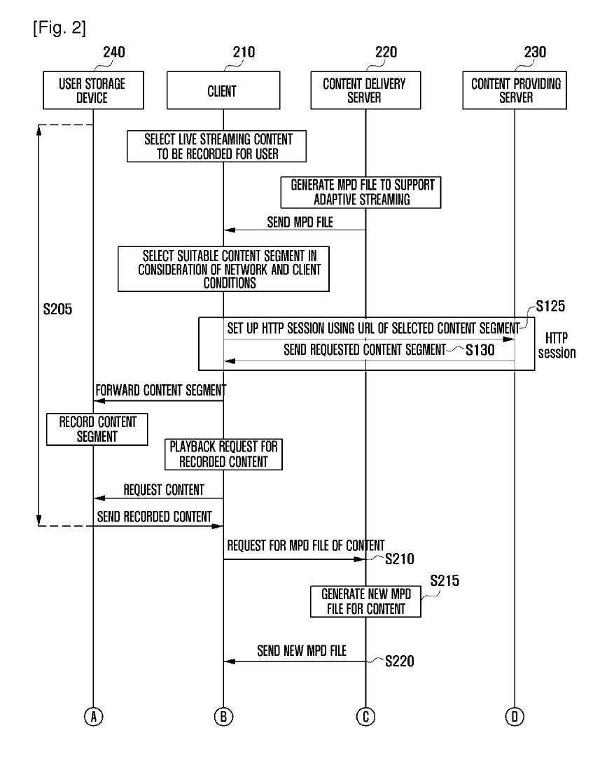

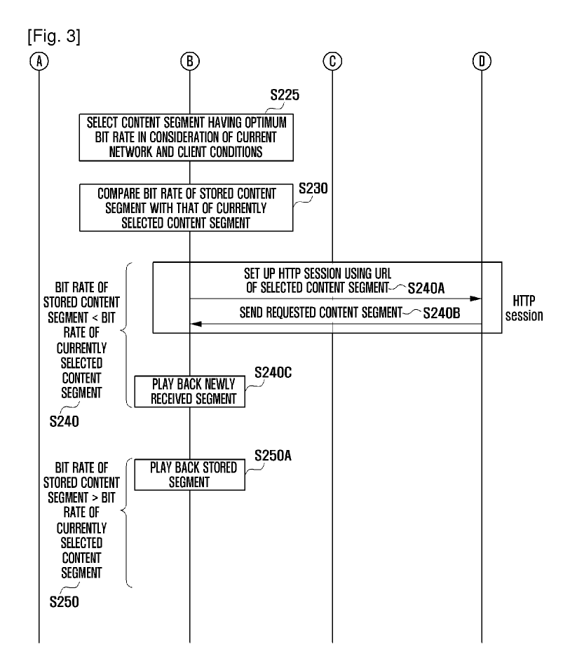

FIGS. 2 and 3 are a sequence diagram illustrating a procedure for playing back recorded content according to an embodiment of the present invention.

Referring to FIG. 2, a content playback apparatus of the present invention may include a client 210, a content delivery server 220, a content providing server 230, and a user storage device 240. In FIG. 2, the client 210 and the user storage device 240 are depicted as being separated. However, such depiction does not indicate that physical separation between the client 210 and the user storage device 240 is required. In a different embodiment, the user storage device 240 may be embedded in the client 210.

Step S205 for requesting, receiving and storing a desired content segment in FIG. 2 is the same as the procedure described in FIG. 1, and a description thereof is omitted.

When the user makes a playback request for the recorded content, the client 210 sends a request for an MPD file of the same content to the content delivery server 220 (S210). The content delivery server 220 newly generates the MPD file for the content (S215). The reason for MPD file regeneration is that MPD information on the content such as the storage address thereof may be changed after live streaming of the content. The content delivery server 220 sends the newly generated MPD file to the client 210 (S220).

The client 210 selects a content segment having an optimum bit rate in consideration of network and client conditions on the basis of the new MPD file (S225). The client 210 compares the bit rate of the content segment stored in the user storage device 240 with that of the content segment selected after the playback request, i.e., at step S225 (S230). Here, the compared content segments may be the same or different versions of an identical content segment.

When the bit rate of the content segment selected after the playback request is greater than that of the content segment stored in the user storage device 240, the client 210 performs step S240. That is, the client 210 tries to play back the higher quality content segment instead of playing back the stored content segment.

More specifically, the client 210 sets up a session with a content providing server storing the selected content segment (S240A). Here, the content providing server storing a content segment being live streamed may be different from the content providing server storing the content segment after live streaming. However, as the client 210 already received a new MPD file at step S220, it can directly access the content providing server storing the desired content segment.

After session setup, the client 210 receives the selected content segment from the content providing server 230 (S240B), and plays back the newly received content segment (S240C).

When the bit rate of the content segment selected after the playback request is less than that of the content segment stored in the user storage device 240, the client 210 performs step S250. That is, as the content segment stored in the user storage device 240 has a higher quality than the currently available content segment, the client 210 plays back the content segment stored in the user storage device 240 (S250A).

To realize the present invention, it is necessary to store content information as illustrated in Table 1 in the client 210 or the user storage device 240 when a content segment related to the live content is stored.

TABLE 1

| | Segment | | |
|---|---|---|---|
| | streaming | | |
| Content ID | time (UTC) | Recorded segment ID (URL) | Bit rate |
| 1 | 1006192015 | www.example.com/rep2/seg-1.3gp | 50M |
| | 1006192015 | www.example.com/rep2/seg-2.3gp | 30M |
| | 1006192017 | www.example.com/rep2/seg-3.3gp | 25M |

As shown in Table 1, the content information to be stored may include at least one of content ID, streaming times of individual content segments, recorded content segment ID, and bit rates of individual content segments. Here, the streaming times may be given by absolute UTC times and the recorded content segment ID may take the form of URL.

The client 210 may perform bit-rate comparison in a segment basis between the content segment stored in the user storage device 240 and the content segment selected after the playback request. Alternatively, the client 210 may compare the average bit rate of all the content segments with the bit rate of the content segment selected after the playback request.

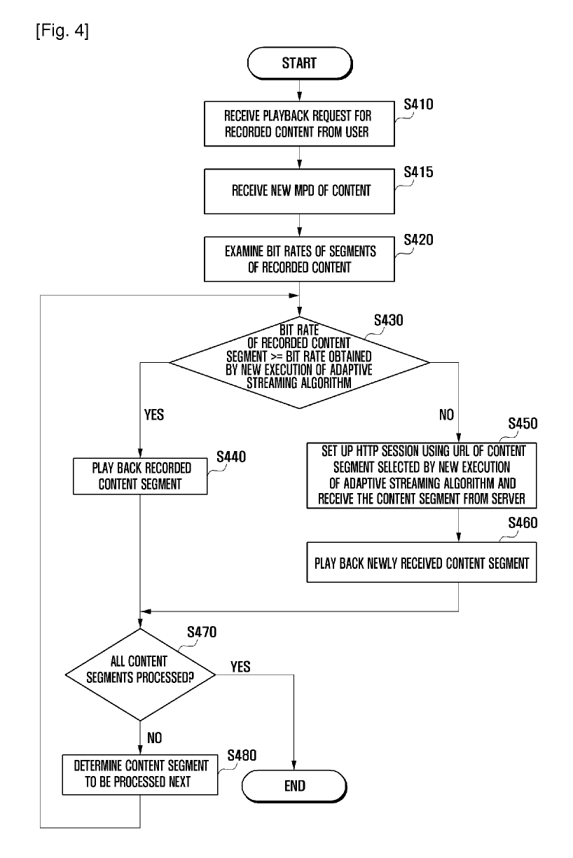

FIG. 4 is a flowchart of a procedure performed by the client 210 according to an exemplary embodiment of the present invention.

First, it is assumed that the client 210 has received and stored (or recorded) a content segment of content having been live streamed.

The client 210 receives a playback request for the recorded content from the user (S410). In response to the playback request, the client 210 receives a newly generated MPD of the corresponding content from the content delivery server 220 (S415). The newly generated MPD is necessary because configuration information of particular content may be changed after live streaming.

The client 210 examines the bit rate of a content segment of the recorded content (S420). The client 210 selects a content segment having an optimum bit rate on the basis of the new MPD and compares the bit rate of the recorded content segment with that of the newly selected content segment (S430). Here, the compared content segments may be the same or different versions of an identical content segment.

When the bit rate of the recorded content segment is greater than that of the newly selected content segment, the client 210 plays back the recorded content segment stored in the user storage device 240 (S440).

When the bit rate of the recorded content segment is less than that of the newly selected content segment, the client 210 sets up an HTTP session to a URL at which the newly selected content segment is stored and receives the newly selected content segment (S450), and plays back the newly received content segment (S460).

After segment playback at step S440 or step S460, the client 210 checks whether all content segments have been processed (S470). When not all content segments have been processed, the client 210 determines a content segment to be processed next (S480) and returns to step S430. When all content segments have been processed, the client 210 ends the procedure.

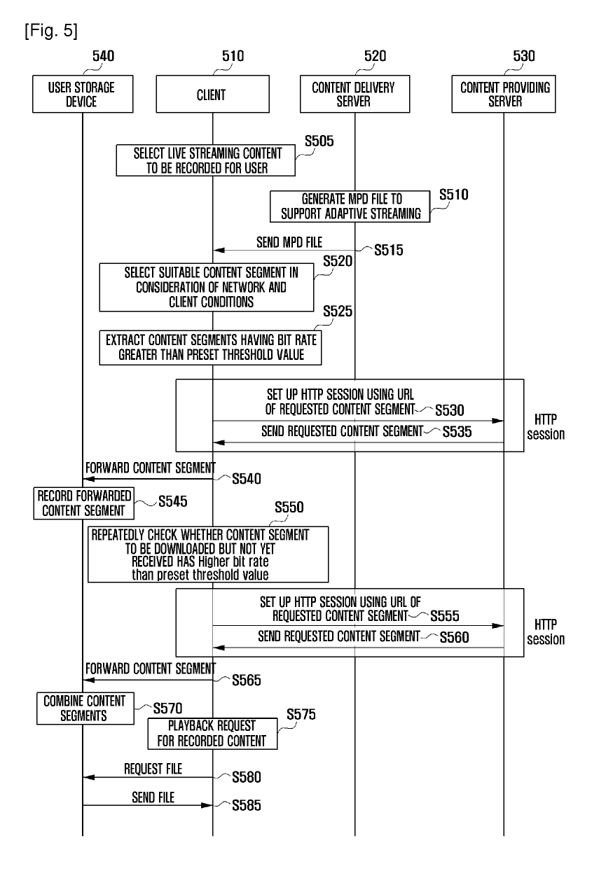

FIG. 5 is a sequence diagram illustrating a procedure for playing back recorded content according to another embodiment of the present invention.

Referring to FIG. 5, the client 510 selects live streaming content to be recorded according to user selection (S505). The content delivery server 520 generates content configuration information to support adaptive streaming for the selected live content (S510). Here, the content configuration information enables the client 510 to play back desired content, and may include at least one of content address like URL, streaming time, the number of segments, duration of each segment and bandwidth of each segment. The content configuration information may be a media presentation description (MPD) file. In the following description, the content configuration information is assumed to be an MPD file. The content delivery server 520 sends the generated MPD file to the client 510 (S515).

The client 510 examines the received MPD file to select content segments having an optimum bit rate in consideration of current network and client conditions as content segments to be downloaded (S520). The client 510 creates a list of content segments having a bit rate greater than a preset threshold value among the content segments to be downloaded (S525). The client 510 establishes an HTTP session with the content providing server 530 (S530), and receives the content segments having a bit rate greater than the preset threshold value from the content providing server 530 (S535).

The client 510 forwards the received content segments to the user storage device 540 (S540), at which the content segments are recorded and stored (S545). Here, the stored content segments are those content segments having a bit rate greater than the preset threshold value among content segments forming the content to be recorded. Hence, it may be necessary to receive an additional content segment, which has not been received at step S535, from the content providing server 530.

The client 510 checks whether a content segment to be downloaded but not yet received has a bit rate greater than the preset threshold value in consideration of current network and client conditions (S550). When a content segment to be received has a bit rate greater than the preset threshold value, the client 510 establishes an HTTP session with the content providing server 530 (S555), receives the content segment from the content providing server 530 (S560), and forwards the received content segment to the user storage device 540 (S565). Steps S550 to S565 may be repeated until all the content segments forming the content to be recorded are received.

The user storage device 540 combines all the content segments (received at steps S540 and S565) into a single content file (S570). Later, when a playback request for the recorded content is received from the user (S575), the client 510 requests the user storage device 540 to send the stored content (S580), and receives the content and plays back the received content (S585).

As described above in connection with FIG. 5, the client 510 may provide high-quality content to the user by enforcing the content to include content segments whose bit rates are greater than a preset threshold value.

In FIG. 5, in consideration of current network and client conditions, the client 510 receives content segments having a bit rate greater than a preset threshold value first from the server, among contents segments forming the content to be recorded, and then receives the remaining content segments when they have a bit rate greater than the preset threshold value. However, the present invention is not limited thereto. For example, the content providing server 530 may extract content segments having a bit rate greater than the preset threshold value within a preset time and send the extracted content segments to the client 510.

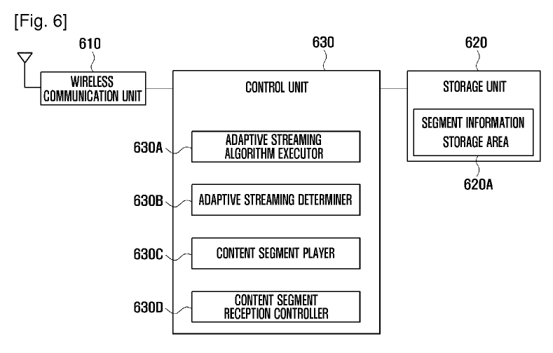

FIG. 6 is a block diagram of the client according to an embodiment of the present invention. As shown in FIG. 6, the client may include a wireless communication unit 610, a storage unit 620 and a control unit 630. In particular, the storage unit 620 includes a segment information storage area 620A; and the control unit 630 includes an adaptive streaming algorithm executor 630A, an adaptive streaming determiner 630B, a content segment player 630C, and a content segment reception controller 630D.

The wireless communication unit 610 wirelessly connects to the content delivery server or the content providing server to send and receive signals. Particularly, in response to a request for content recording, the wireless communication unit 610 may receive an MPD file from the content delivery server. In response to a request for content playback, the wireless communication unit 610 may send a request for an MPD file to the content providing server and receive the MPD file therefrom. The wireless communication unit 610 may establish a session with the content providing server to receive a content segment. Here, the session may be an HTTP session.

The storage unit 620 may store programs and data necessary for operation of the client. In particular, the storage unit 620 acts as the user storage device storing recorded content segments.

The storage unit 620 may include a segment information storage area 620A, which stores detailed information on content segments of a recorded content as in Table 1. The content information in the segment information storage area 620A may include at least one of content ID, streaming times of individual content segments, recorded content segment ID, and bit rates of individual content segments. Here, the streaming times may be given by absolute UTC times and the recorded content segment ID may take the form of URL.

The control unit 630 controls the overall operation of the client. In response to a request for content recording, the control unit 630 may control an operation to store content segments received from the content providing server in the user storage device or the storage unit 620.

The control unit 630 may include an adaptive streaming algorithm executor 630A, an adaptive streaming determiner 630B, a content segment player 630C, and a content segment reception controller 630D.

The adaptive streaming algorithm executor 630A controls a segment reception operation to select one of content segments having the highest bit rate in consideration of network and client conditions and to receive the selected content segment. To achieve this, the adaptive streaming algorithm executor 630A may execute an algorithm to select an optimum bit rate on the basis of an MPD file received from the content delivery server, wireless network environment and client environment, and control an operation to receive a desired content segment having the selected bit rate from the content providing server.

The adaptive streaming determiner 630B controls, in response to a playback request for recorded content, the adaptive streaming algorithm executor 630A to newly calculate an optimum bit rate for receiving content segments forming the recorded content at the time of playback request. Then, the adaptive streaming determiner 630B compares the bit rate of the recorded content segment with the bit rate of the corresponding content segment newly calculated at the time of playback request to determine which of the two content segments to play back.

In response to a playback request for recorded content, the adaptive streaming determiner 630B may create a comparison table as shown in Table 2 to compare the bit rate of the recorded content segment with the recalculated bit rate of the corresponding content segment and determine the content segment having a higher quality level.

TABLE 2

| | | | | Bit rate of |
|---|---|---|---|---|
| | | | Bit rate | segment re- |
| | Segment | | of | computed at |
| | streaming | | recorded | playback |
| Content ID | time (UTC) | Recorded segment ID (URL) | segment | request |
| 1 | 1006192015 | www.example.com/rep2/seg-1.3gp | 50M | 60M |
| | 1006192015 | www.example.com/rep2/seg-2.3gp | 30M | 20M |
| | 1006192017 | www.example.com/rep2/seg-3.3gp | 25M | 30M |
| | — | — | — | — |

When the bit rate of the recorded content segment is less than the recalculated bit rate of the corresponding content segment, the adaptive streaming determiner 630B sets up a session with the content providing server and newly receives the corresponding content segment therefrom without playback of the recorded content segment.

When the bit rate of the recorded content segment is greater than the recalculated bit rate of the corresponding content segment, the adaptive streaming determiner 630B controls an operation to play back the recorded content segment.

The content segment player 630C plays back a content segment being live streamed or a content segment recorded (stored) in the storage unit 620.

The content segment reception controller 630D in the control unit 630 may be used to realize another embodiment.

In response to a recording request for content, the content segment reception controller 630D identifies bit rates of individual content segments forming the content in consideration of current network and client conditions, selects content segments to be downloaded, and controls an operation to receive those content segments having a bit rate greater than a preset threshold value among the content segments to be downloaded. The content segment reception controller 630D repeatedly checks whether a content segment, among the content segments not yet received, has a bit rate greater than the preset threshold value in consideration of current network and client conditions, establishes, when a content segment has a bit rate greater than the preset threshold value, a session with the content providing server storing the content segment, and receives the content segment from the content providing server.

In FIG. 6, the functions of the control unit 630 are described in terms of the adaptive streaming algorithm executor 630A, adaptive streaming determiner 630B, content segment player 630C and content segment reception controller 630D. However, this does not necessarily mean that the control unit 630 should be divided into such functional blocks. The control unit 630 may perform all the necessary functions without such functional blocks.

As described above, the present invention enables the user to play back recorded content in a better quality level by comparing the bit rate of a recorded content segment with the optimal bit rate of the corresponding content segment in consideration of network and client conditions at the time of playback request.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

1. A method of playing back recorded content for a client in a wireless communication system, comprising:
accepting a playback request for recorded content;
selecting a first bit rate of a content segment forming the streaming content at the time of playback request;
comparing a second bit rate of a content segment forming the recorded content with the first bit rate selected at the time of playback request; and
playing back one of the content segment forming the recorded content and a corresponding content segment received from a content providing server according to the comparison results.

2. The method of claim 1, wherein playing back comprises playing back, when the second bit rate is greater than the first bit rate, the content segment forming the recorded content.

3. The method of claim 1, wherein playing back comprises playing back, when the first bit rate is greater than the second bit rate, the corresponding content segment received from the content providing server.

4. The method of claim 1, further comprising recording desired streaming content before accepting a playback request, and wherein recording desired streaming content comprises storing content information including at least one of content ID, streaming times of content segments, recorded content segment ID and bit rates of content segments.

5. The method of claim 1, further comprising:
sending, after accepting a playback request, a request for content configuration information of the recorded content to a content delivery server; and
receiving the content configuration information from the content delivery server.

6. The method of claim 5, wherein the content configuration information includes at least one of content storage address, streaming time, the number of segments, duration of each segment and bandwidth of each segment.

7. The method of claim 1, wherein comparing a second bit rate comprises comparing bit rates of a recorded content segment and a content segment selected after playback request which are versions of the same content segment.

8. A content playback apparatus for playing back recorded content in a wireless communication system, comprising:
a wireless communication unit connecting to a content delivery server or a content providing server to send and receive signals;
a storage unit storing recorded content; and
a control unit controlling a process of selecting, in response to a playback request for recorded content, a first bit rate of a content segment forming streaming content, comparing a second bit rate of a content segment forming the recorded content with the first bit rate selected at the time of playback request, and playing back one of the content segment forming the recorded content and a corresponding content segment received from the content providing server according to the comparison results.

9. The content playback apparatus of claim 8, wherein the control unit plays back, when the second bit rate is greater than the first bit rate, the content segment forming the recorded content.

10. The content playback apparatus of claim 8, wherein the control unit plays back, when the first bit rate is greater than the second bit rate, the corresponding content segment received from the content providing server.

11. The content playback apparatus of claim 8, wherein the storage unit stores, for the recorded content, content information including at least one of content ID, streaming times of content segments, recorded content segment ID and bit rates of content segments.

12. The content playback apparatus of claim 8, wherein the control unit controls an operation to receive content configuration information of the recorded content from the content delivery server in response to the playback request.

13. The content playback apparatus of claim 8, wherein the control unit compares bit rates of a recorded content segment and a content segment selected after playback request which are versions of the same content segment.

14. A method of playing back recorded content for a client in a wireless communication system, comprising:
examining, in response to a recording request for content, bit rates of content segments forming the requested content and identifying content segments to be downloaded;
selecting content segments having a bit rate greater than or equal to a preset threshold value among the content segments forming the requested content, and receiving the selected content segments from a content providing server and storing the received content segments;
receiving, when an additional content segment that is a content segment to be downloaded and is not yet received from the content providing server has a bit rate greater than or equal to the preset threshold value, the additional content segment from the content providing server and storing the received additional content;
combining the received content segments; and
playing back, in response to a playback request for recorded content, the combined content segments.

15. A content playback apparatus for playing back recorded content in a wireless communication system, comprising:
a wireless communication unit connecting to a content delivery server or a content providing server to send and receive signals;
a storage unit storing recorded content; and
a control unit controlling a process of examining, in response to a recording request for particular content, bit rates of content segments forming the requested content and identifying content segments to be downloaded, selecting content segments having a bit rate greater than or equal to a preset threshold value among the content segments forming the requested content, receiving the selected content segments from a content providing server and storing the received content segments, and further receiving, when an additional content segment that is a content segment to be downloaded and is not yet received from the content providing server has a bit rate greater than or equal to the preset threshold value, the additional content segment from the content providing server and storing the received additional content.
